(19) United States
(12) Patent Application Publication
(10) Pub. No.: US 2010/0220130 A1
(43) Pub. Date: Sep. 2, 2010

(54) AVOIDING PRINTHEAD CONTACT

(76) Inventors: Javier GONZALEZ BRUNO, Terrassa (ES); Angel Martinez, Barcelona (ES); Daniel Blanch Escude, Barcelona (ES)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/394,167

(22) Filed: Feb. 27, 2009

(51) Int. Cl. B41J 29/38

(52) U.S. Cl. 347/9

(57) ABSTRACT

A system for avoiding printhead contact is disclosed. In one embodiment, the system includes a detector switch configured to detect printhead contact, and a processor that is coupled to the detector switch and is configured to initiate action to avoid printhead contact.

### BACKGROUND OF THE INVENTION

Cellulous-based media and other media can deform when an inkjet printing device fires ink upon the media. Media deformation can occur in all directions if a sufficient amount of ink is applied. For example, media deformation may occur when printing on a large portion of the media with high ink densities. Also, media deformation can occur when using media that is thinner or more porous than media for which the print device was designed.

Depending upon the severity of the media deformation, the following negative events can occur:
a. Ink smearing: This may appear as an ink stain in the final printout. Ink smearing happens because media deformation in a vertical direction is such that the printheads touch the media while printing.
b. Media damage. If media deformation is sufficiently high in a vertical direction, wet media may be ripped by a printhead edge.
c. Head crash: Extreme media deformation can cause a paper jam and damage to the printhead.

The possible consequences of the media deformation events described above may go beyond the user having to scrap the printout and repeat the job. Media particles may get inside the printhead nozzles and clog them. Contact between the printhead and media may cause scratching of printhead nozzle plates. Clogged printhead nozzles and scratched printhead nozzle plates present a significant problem as users may not be able to remedy the issue through servicing routines and may need to replace the damaged printheads.

### BRIEF DESCRIPTION OF THE DRAWINGS

The invention provides a system for avoiding printhead contact including a detector switch configured to detect imminent contact of a printhead, and a processor that is coupled to the detector switch and configured to initiate an action to avoid printhead contact.

The invention further provides a method for avoiding printhead contact including using a detector switch to detect imminent contact of a printhead, communicating information regarding the detected imminent contact to a processor; and initiating an avoidance action.

The invention further provides a scanning carriage including at least one detector switch configured to detect imminent contact of a printhead with media.

The accompanying drawings illustrate various embodiments of the principles described herein and are a part of the specification. The illustrated embodiments are merely examples and do not limit the scope of the claims. Throughout the drawings, identical reference numbers designate similar, but not necessarily identical elements.

FIG. 1 is a diagram showing a lateral view of an inkjet printing device and media without deformation, according to an embodiment of an inkjet printing device.

FIG. 2 is a diagram showing a lateral view of an inkjet printing device and the consequences of a degree of media deformation, according to an embodiment of an inkjet printing device.

FIG. 3 is a diagram showing a lateral view of an inkjet printing device and the consequences of a degree of media deformation, according to an embodiment of an inkjet printing device.

FIG. 4 is a diagram showing a lateral view of an inkjet printing device and the consequences of a degree of media deformation, according to an embodiment of an inkjet printing device.

FIG. 5 is a diagram showing a lateral view of a scanner carriage configured to avoid printhead contact, according to an embodiment of the invention.

FIG. 6 is a diagram showing a lateral view of a scanner carriage configured to avoid printhead contact as it encounters media deformation, according to an embodiment of the invention.

FIG. 7 is a diagram showing a lateral view of a system for avoiding printhead contact as implemented in an inkjet printing device, according to an embodiment of the invention.

FIG. 8 is a diagram showing a top-down view of a system for avoiding printhead contact as implemented in an inkjet printing device, according to an embodiment of the invention.

FIG. 9 is a diagram showing a lateral view of a detector device, according to an embodiment of the invention.

FIG. 10 is a diagram showing a method of avoiding printhead contact, according to an embodiment of the invention.

FIG. 11 is a diagram showing a method of avoiding printhead contact, according to an embodiment of the invention.

### DETAILED DESCRIPTION OF EMBODIMENTS

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an embodiment”, “an example” or similar language means that a particular feature is included in at least that one embodiment, but not necessarily in other embodiments. The various instances of the phrase “in one embodiment” or similar phrases in various places in the specification are not necessarily all referring to the same embodiment. The terms “comprises/comprising”, “has/having”, and “includes/including” are synonymous, unless the context dictates otherwise.

The accompanying drawings illustrate various embodiments of the principles described herein and are a part of the specification. The illustrated embodiments are merely examples and do not limit the scope of the claims. Throughout the drawings, identical reference numbers designate similar, but not necessarily identical elements.

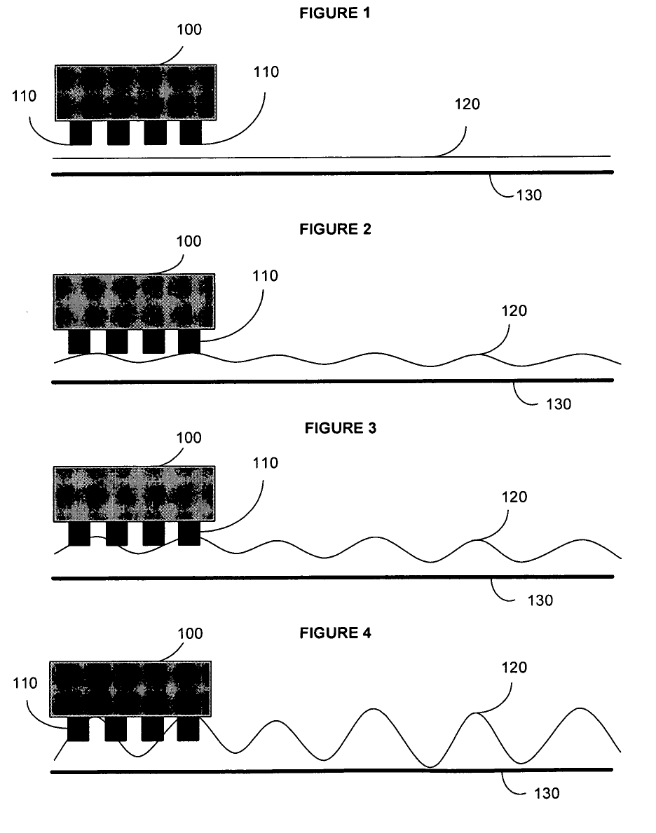

FIG. 1 is a diagram showing a lateral view of an inkjet printing device and media without deformation, according to an embodiment of an inkjet printing device. FIG. 1 illustrates scanning carriage 100 and printhead 110 components of an inkjet printing device, positioned above the media 120 to be printed upon. As used in the present specification and in the appended claims, the term “scanning carriage” suggests a mechanism which scans across media as such media is fed through the printing device by the printing device's media feed apparatus. As used in the present specification and in the appended claims, the term “printhead” suggests an element of the printing device that applies the ink to media. In an example, the printheads 110 are thermally actuated inkjet printheads that are contained within, and protrude from the bottom of, the scanning carriage. As used in the present specification and in the appended claims, the term “media” suggests paper or any other object that can be printed upon. In an embodiment the media may be cellulose based paper media.

When the printing operation is initiated the scanning carriage 100 containing the printheads 110 is scanned across media 120 resting in a print zone 130, so as to print a swath of ink on the media 120. When all of the characters in the swath have been printed, the media advances a new area of the media 120 into the print zone 130 for printing. The entire process repeats until everything that is to be printed on the media has been printed. In this example the media 120 is not deformed, such that there is an appropriate spacing between the printheads 110 and the media 120. In this example there is no damage to the media or the printing device attributable to contact between the printheads 110 and media 120.

FIG. 2 is a diagram showing a lateral view of an inkjet printing device and the consequences of a degree of media deformation, according to an embodiment of an inkjet printing device. FIG. 2 illustrates scanning carriage 100 and printhead 110 components of an inkjet printing device, positioned above the media 120 to be printed upon. In this example the media 120 is mildly deformed in the vertical aspect, such that there printheads 110 and media 120 are touching at some points during the printing process. Such touching can result in ink smearing and appear as an ink stain in the final printout.

FIG. 3 is a diagram showing a lateral view of an inkjet printing device and the consequences of a degree of media deformation, according to an embodiment of an inkjet printing device. FIG. 3 illustrates scanning carriage 100 and printhead 110 components of an inkjet printing device, positioned above the media 120 to be printed upon. In this example the media 120 is moderately deformed in the vertical aspect, such that the contact between printheads 110 and media 120 is creates more pressure and is more sustained than the contact illustrated in FIG. 1. Due to the increased wetness of the media 120, such contact can result in the media 120 being torn by a printhead 110 edge or other printing device components.

FIG. 4 is a diagram showing a lateral view of an inkjet printing device and the consequences of a degree of media deformation, according to an embodiment of an inkjet printing device. FIG. 4 illustrates scanning carriage 100 and printhead 110 components of an inkjet printing device, positioned above the media 120 to be printed upon. In this example the media 120 is severely deformed in the vertical aspect. In addition to the problems described in FIG. 3 that can be attributed to moderate media deformation, contact between printheads 110 and severely deformed media 120 may result in a “head crash” causing damage to the printhead 110 and jamming of the printing device. Damage may occur in the form of media particles clogging the printhead 110, or the scratching of printhead 110 nozzle plates. Users may not be able to remedy these problems through servicing routines, and may need to replace the damaged printheads.

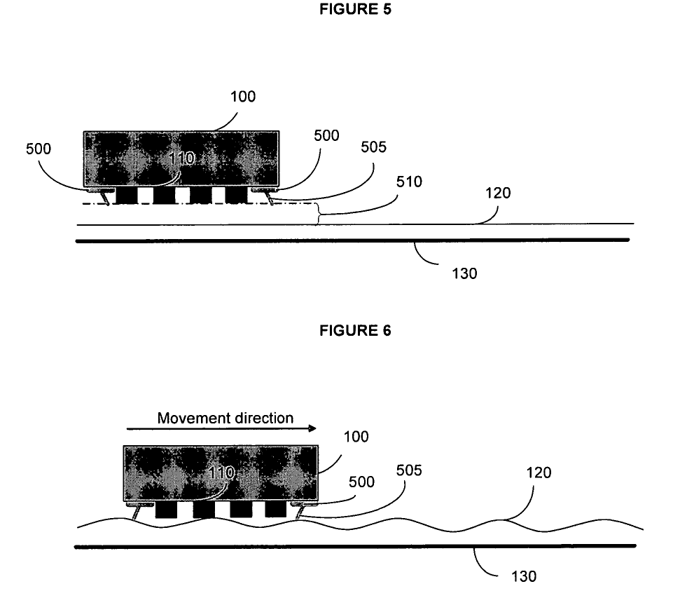

FIG. 5 is a diagram showing a lateral view of a scanner carriage configured to avoid printhead contact, according to an embodiment of the invention. As in FIG. 1, FIG. 5 illustrates a lateral view of a scanning carriage 100 and a printhead 110 positioned above the media 120 to be printed upon. In this example the media 120 is not deformed, such that there is an appropriate spacing between the printheads 110 and the media 120. In this embodiment detector switches 500 and installed at each end of the scanning carriage, next to the printheads 110. In an embodiment, an activation component 505 protrudes from each detector switch such that such that deformed media 120 or another object approaching the printhead will trigger the activation component 505 prior to colliding with a printhead 110.

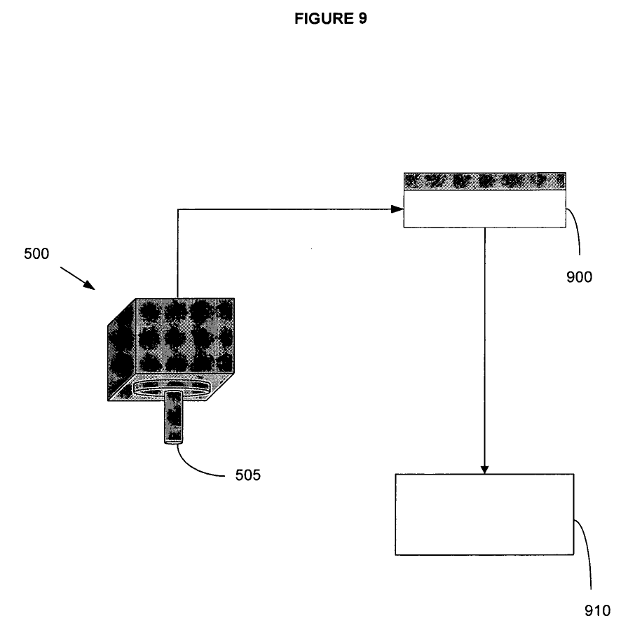

FIG. 6 is a diagram showing a lateral view of a scanner carriage configured to avoid printhead contact, as it encounters media deformation, according to an embodiment of the invention. In this example the media 120 is mildly deformed in the vertical aspect, such that printheads 110 and media 120 will touch at some points during the printing process. Such touching can result in ink smearing and appear as an ink stain in the final printout. In this embodiment detector switches 500 are installed at each end of the scanning carriage, next to the printheads 110, and coupled to a processor FIG. 9, 900. In this embodiment the detector switches 500 are configured to detect the deformed media and to send an electronic signal to a processor FIG. 9, 900 to the effect that contact with a printhead 110 is imminent. The processor FIG. 9, 900 is configured to halt the printing process and move the printheads 110 to a safe position in the printing device.

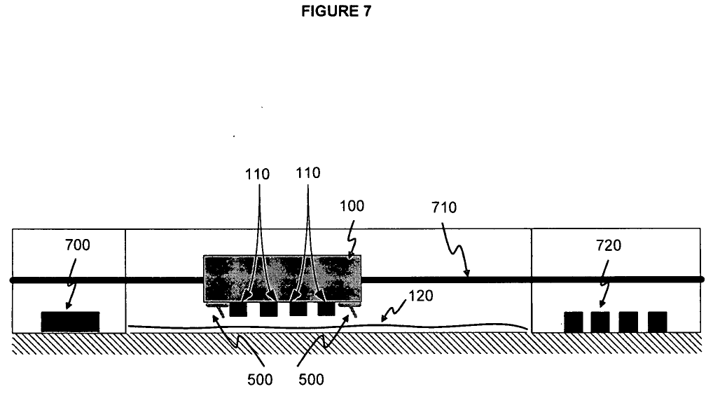

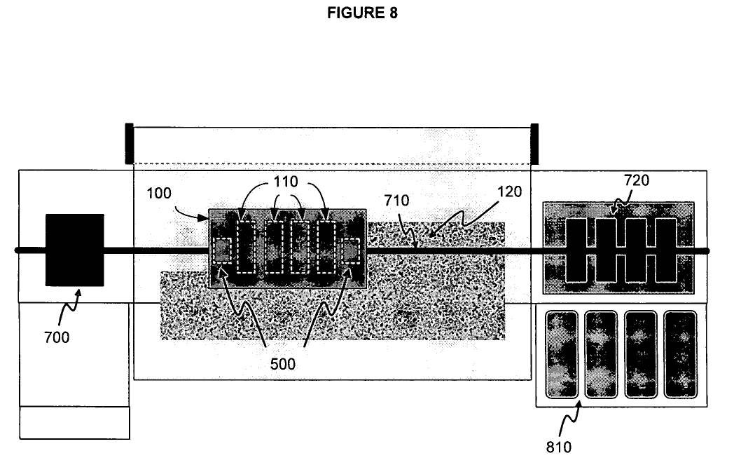

FIG. 7 is a diagram showing a lateral view of a system for avoiding printhead contact as implemented in an inkjet printing device, according to an embodiment of the invention. FIG. 8 illustrates this embodiment from a top-down view. In this embodiment, detector switch 500 is configured such that if the detector switch 500 detects imminent contact with deformed media 120 or any other obstacle of such height that it would make contact with a printhead 110, the detector switch 500 sends an electronic signal to the processor FIG. 9, 900. In an embodiment the processor FIG. 9, 900 is configured to in turn initiate action to avoid printhead 110 contact by moving the scanning carriage 100 and its attached printheads 110 away from the point of imminent contact with deformed media 120 along the carriage rod 710. In an example, processor FIG. 9, 900 is configured to initiate the movement of the scanning carriage 100 and its attached printheads 100 to a safe parked position in the printing device's service station 720 located to the right extremity of the scanning carriage's 100 path. In an embodiment, the processor FIG. 9, 900 is configured to initiate the movement of the scanning carriage 100 and attached printheads 110 away from the deformed media 120 and adjacent to the printing device spittoon 700 located to the left extremity of the scanning carriage's 100 path.

FIG. 9 is a diagram showing a lateral view of an individual detector device 500, according to an embodiment of the invention. When implemented, the detector device is coupled to a processor 900. The detector device 500 is configured to send an electronic signal to the processor 900 when the detector device's 500 activation component 510 encounters deformed media 120 or another object. In an embodiment the activation component 510 is a mechanical toggle that moves from an open to closed position and sends an electronic signal to a processor when it encounters deformed media 120. In an embodiment, the processor 900 is configured to initiate avoidance actions including terminating the print job and returning the scanning carriage 100 to its resting position within the printing device service station 720. In an embodiment, the processor 900 is configured to communicate corrective advice to a use via a display device 910 situated on the outside of the printing device.

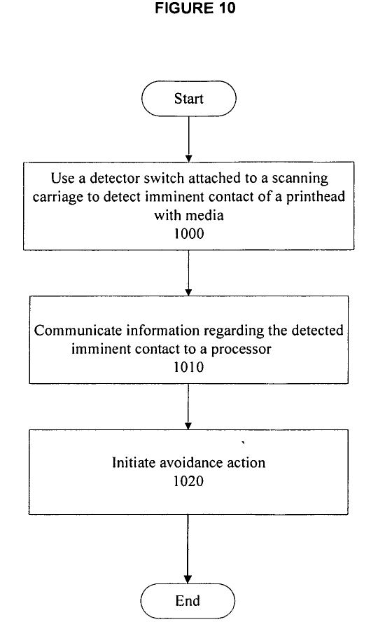

FIG. 10 is a flowchart of one embodiment of the invention, a method of avoiding printhead contact. The method of FIG. 10 begins at block 1000 in which a detector switch attached to a scanning carriage is used to detect imminent contact between a printhead and deformed media. In an embodiment the detector switch detects deformed media or another object by virtue of contact between the detectors switch's activation component and the media. The method continues as block 1010 in which information regarding the imminent printhead contact is communicated to a processor. In an embodiment, the communication occurs by virtue of the detector device sending an electronic signal to the processor when activated by contact with media. The method continues at block 1020 in which action to avoid printhead contact is initiated. In an embodiment, avoidance action constitutes sending a signal to the other printing device components so as to stop scanning carriage movement and terminate the printing operation.

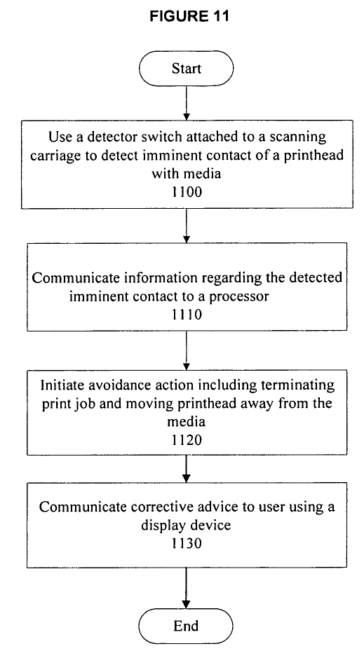

FIG. 11 is a flowchart of one embodiment of the invention, a method of avoiding printhead contact. The method of FIG. 11 begins at block 1100 in which a detector switch attached to a scanning carriage is used to detect imminent contact between a printhead and deformed media. The method continues as block 1110 in which information regarding the imminent printhead contact is communicated to a processor. The method continues at block 1120 in which action to avoid printhead contact is initiated. In an embodiment, avoidance action constitutes sending an electronic signal to the other printing device components so as to terminate the printing process and returning the scanning carriage to its resting position within the printing device service station. The method continues at block 1130 in which the processor communicates corrective advice to a the user. In an embodiment, such communication is via a display device on the outside of the printing device.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system for avoiding printhead contact, comprising:
at least one detector switch attached to a scanning carriage configured to detect imminent contact of a printhead with a media; and
at least one processor coupled to the at least one detector switch and configured to initiate an action to avoid printhead contact with the media.

2. The system of claim 1, wherein the at least one detector switch is configured to send an electronic signal to the processor when activated.

3. The system of claim 1, wherein the at least one detector switch includes an activation component protruding from the detector switch such that deformed media approaching the printhead will trigger the activation component prior to colliding with the printhead.

4. The system of claim 1, wherein the action to avoid printhead contact comprises terminating a printing process.

5. The system of claim 1, wherein the action to avoid printhead contact comprises stopping a print job and moving the printhead away from the media.

6. The system of claim 1, wherein the action to avoid printhead contact comprises terminating a printing process and moving the printhead to a printhead service station.

7. The system of claim 1, further comprising at least one display device coupled to the at least one processor configured to communicate corrective advice.

8. A scanning carriage configured
to position at least one printhead above a media and move the at least one printhead back and forth in front of the media, and
to avoid printhead contact with the media,
wherein the scanning carriage comprises at least one detector switch configured to detect imminent contact of the at least one printhead with the media.

9. The scanning carriage of claim 8, wherein the at least one detector switch is configured to send an electronic signal to a processor that is configured to initiate action to avoid printhead contact with the media.

10. The scanning carriage of claim 8, wherein the at least one detector switch is configured to send an electronic signal to a processor that is configured to terminate a print job.

11. The scanning carriage of claim 8, wherein the at least one detector switch is configured to send an electronic signal to a processor that is configured to terminate a printing process and move the at least one printhead away from the media.

12. The scanning carriage of claim 8, wherein the detector switch includes an activation component protruding from the detector switch such that deformed media approaching the printhead will trigger the activation component prior to colliding with the printhead.

13. The scanning carriage of claim 8, wherein the at least one detector switch is configured to send an electronic signal to a processor that is configured to communicate corrective advice to a user.

14. A method for avoiding printhead contact, comprising:
using at least one detector switch attached to a scanning carriage to detect imminent contact of a printhead with a media;
communicating information regarding the detected imminent contact to a processor; and
initiating an avoidance action.

15. The method of claim 14, wherein the at least one detector switch is configured to send an electronic signal to the processor when activated.

16. The method of claim 14, wherein the avoidance action comprises terminating a printing process.

17. The method of claim 16, wherein the avoidance action further comprises moving the printhead away from the media.

18. The method of claim 14, further comprising communicating corrective advice to a user.

19. The method of claim 18, wherein the corrective advice is communicated using a display device.

20. The method of claim 14, wherein the at least one detector switch includes an activation component protruding from the detector switch such that deformed media approaching the printhead will trigger the activation component prior to colliding with the printhead.
